(19) United States
(12) Patent Application Publication
(10) Pub. No.: US 2011/0214994 A1
(43) Pub. Date: Sep. 8, 2011

(54) PRETREATING AGENT FOR ELECTROPLATING, PRETREATMENT METHOD FOR ELECTROPLATING, AND ELECTROPLATING METHOD

(75) Inventors: Masayuki Utsumi, Osaka (JP); Naoyuki Omura, Osaka (JP); Takuya Okamachi, Osaka (JP)

(73) Assignee: C. UYEMURA & CO., LTD, Osaka (JP)

(21) Appl. No.: 13/037,900

(22) Filed: Mar. 1, 2011

(30) Foreign Application Priority Data
Mar. 2, 2010 (JP) 2010-045405

(51) Int. Cl. C25D 5/34; C09K 3/00

(52) U.S. Cl. 205/211; 252/182.12

(57) ABSTRACT

A pretreating agent for electroplating includes an aqueous solution containing, as essential ingredient, (A) at least one anti-adsorption agent selected from among a triazole compound, a pyrazole compound, an imidazole compound, a cationic surfactant, and an amphoteric surfactant, and (B) chloride ion. The pretreating agent does not impair adhesion between substrate copper and a photoresist, and does not damage adhesion between the substrate copper and an electrolytic copper plating film.

### CROSS-REFERENCE TO RELATED APPLICATION

This non-provisional application claims priority under 35 U.S.C. §119(a) on Patent Application No. 2010-045405 filed in Japan on Mar. 2, 2010, the entire contents of which are hereby incorporated by reference.

### TECHNICAL FIELD

The present invention relates to a pretreating agent for electroplating and a pretreatment method for electroplating which are preferable for use in pretreating a printed wiring board, particularly one in which a photoresist (ink or dry film) for circuit formation has been applied onto a copper layer, and relates also to an electroplating method.

### BACKGROUND ART

Printed wiring boards include double side printed wiring boards and multilayer printed wiring boards, in which via holes and through-holes are provided for formation of circuit between layers. The via holes and through-holes are subjected to electroless copper plating for forming interlayer connections, and a photoresist layer is formed on the substrate surface for formation of circuit. Thereafter, the substrate is pretreated, and subjected to electrolytic copper plating, to secure the copper thickness necessary for the copper films to serve as conductor.

The photoresist is designed particularly to be stripped in an alkaline condition. Therefore, pretreating agents used in pretreatment for copper electroplating are mostly neutral or acidic, particularly acidic. Existing acidic pretreating agents, in general, contain a surfactant and an inorganic acid or organic acid. The acidic pretreating agent is often used for imparting wettability to via holes and through-holes or removing dirt or scum from the copper or copper alloy surface, before carrying out the electrolytic copper plating.

The substrate copper film (electroless copper plating film or copper foil) for circuit formation may undergo surface oxidation depending on the chemicals, cleaning, uneven drying, etc. in development of the photoresist, and the resulting oxide may impair the adhesion between the electrolytic copper plating film and the substrate copper layer.

The existing acidic pretreating agents have been considered to be weak in cleaning effect on the oxide film on the copper surface. Therefore, in order to obtain a better cleaning effect, there has been a demand for development of a pretreating agent which can remove the oxide film strongly. However, too strong cleaning may worsen the adhesion between the substrate copper and the photoresist, possibly resulting in peeling of the photoresist.

Incidentally, related art references pertaining to the present invention include Japanese Patent No. 2604632, JP-A H3-191077, JP-A 2001-089882, Japanese Patent No. 4208826, JP-A 2009-132967, JP-A H10-212593, JP-A 2005-113162, Japanese Patent No. 4090951, JP-A 2005-333104, and JP-A 2000-104177.

### SUMMARY OF INVENTION

Thus, there has been a need for a pretreating agent for electroplating which impairs neither adhesion between substrate copper and a photoresist nor adhesion between the substrate copper and an electrolytic copper plating film, and also for a pretreatment method for electroplating in which the pretreating agent is used and an electroplating method in which the pretreatment method is used.

In order to fulfill the above need, the present inventors made intensive and extensive investigations. As a result of their investigations, the present inventors found out that when an anti-adsorption agent component having little bad influence on the above-mentioned adhesion is adsorbed on the substrate surface before a resist-eluting component having considerable bad influence on the adhesion, and then cleaning which is not so strong is conducted, instead of strong cleaning which has been considered to be necessary, it is possible to fulfill the above-mentioned need. Based on this finding, the present invention has been completed.

Accordingly, the present invention provides a pretreating agent for electroplating, a pretreatment method for electroplating, and an electroplating method which are characterized as follows.

The pretreating agent for electroplating pertaining to the present invention is characterized in that it includes an aqueous solution containing:

(A) at least one anti-adsorption agent selected from among a triazole compound, a pyrazole compound, an imidazole compound, a cationic surfactant and an amphoteric surfactant; and

(B) chloride ion,

as essential ingredients.

In the pretreating agent for electroplating, preferably, the component (A) is at least one selected from among a cationic surfactant and an amphoteric surfactant. More preferably, the component (A) is an amphoteric surfactant.

In addition, in the pretreating agent for electroplating, preferably, the aqueous solution further contains (C) a nonionic surfactant.

In the pretreating agent for electroplating, preferably, the aqueous solution further contains (D) at least one solvent selected from among water-soluble ethers, amines, alcohols, glycol ethers, ketones, esters, and fatty acids. More preferably, the component (D) includes at least one solvent selected from among water-soluble ethers, alcohols, ketones, esters, and fatty acids.

In addition, in the pretreating agent for electroplating, preferably, the aqueous solution further contains (E) an acid.

In the pretreating agent for electroplating, preferably, the aqueous solution further contains (F) an oxidizing agent.

The pretreatment method for electroplating pertaining to the present invention is characterized in that it includes immersing a work in the above-mentioned pretreating agent for electroplating.

In the pretreatment for electroplating, preferably, an ultrasonic treatment is also conducted upon immersing the work in the pretreating agent. Alternatively, an electrolyzing treatment is also conducted upon immersing the work.

The electroplating method pertaining to the present invention is characterized in that the pretreatment method for electroplating as above-mentioned is used.

### ADVANTAGEOUS EFFECTS OF INVENTION

The pretreating agent for electroplating pertaining to the present invention does not impair adhesion between substrate copper and a photoresist, and does not damage adhesion between the substrate copper and an electrolytic copper plating film.

### BRIEF DESCRIPTION OF DRAWING

FIG. 1 illustrates schematically a method for evaluation of adhesion between substrate copper and a plating film in Examples.

### DESCRIPTION OF EMBODIMENTS

Now, the present invention will be described in detail below.

The pretreating agent for electroplating according to the present invention includes an aqueous solution containing:

(A) at least one anti-adsorption agent selected from among a triazole compound, a pyrazole compound, an imidazole compound, a cationic surfactant and an amphoteric surfactant; and

(B) chloride ion,

as essential ingredients.

### (A) Anti-Adsorption Agent

The anti-adsorption agent (A) in the present invention is adsorbed onto a metallic surface with priority, thereby acting to restrain the adsorption of a photoresist-eluting component on the metallic surface. The anti-adsorption agent (A) in the present invention is a triazole compound, a pyrazole compound, an imidazole compound, a cationic surfactant or an amphoteric surfactant, which may be used singly or in combination of two or more of them. The molecular weight (in the case of a polymer, it means the weight average molecular weight) of the component (A) in the present invention is preferably up to 1,000, particularly in the range of 60 to 900.

Specific examples of the triazole compound include triazole, benzotriazole, methylbenzotriazole, aminotriazole, aminobenzotriazole, and hydroxybenzotriazole. Specific examples of the pyrazole compound include pyrazole, dimethylpyrazole, phenylpyrazole, methylphenylpyrazole, and aminopyrazole. Specific examples of the imidazole compound include imidazole, methylimidazole, and phenylimidazole.

Examples of the cationic surfactant include those of alkyltrimethylammonium type, dialkyldimethylammonium type, trialkylmethylammonium type, tetraalkylammonium type, benzyl type, pyridinium type, diammonium type, or amine salt type. Examples of the amphoteric surfactant include those of amine oxide type, betaine type, imidazoline type, aminodiacetic acid type, alanine type, glycine type, sulfuric ester type, sulfonic ester type, or phosphoric ester type.

Where a triazole compound, a pyrazole compound or an imidazole compound is used as the component (A) in the present invention, the concentration thereof is preferably 0.01 to 200 g/L, particularly 0.05 to 10 g/L. If the concentration is less than 0.01 g/L, the adsorption amount may be too small to successfully obtain the effect of the present invention. On the other hand, if the concentration exceeds 200 g/L, it may cause peeling of the photoresist, and economy is lowered.

Where a cationic surfactant or an amphoteric surfactant is used as the component (A) in the present invention, the concentration thereof is preferably 0.01 to 200 g/L, particularly 0.5 to 10 g/L. If the concentration is less than 0.01 g/L, the adsorption amount may be too small to successfully obtain the effect of the present invention. If the concentration exceeds 200 g/L, on the other hand, it may cause peeling of the photoresist, and economy is lowered. Incidentally, as the cationic surfactant and the amphoteric surfactant, those which are commercially available can be used.

### (B) Chloride Ion

The chloride ions (B) in the present invention are adsorbed on grain boundaries of the metal under consideration, thereby functioning to enhance uniformity of cleaning performance of the metallic surface. Examples of the compound for supplying the chloride ions include hydrochloric acid, ammonium chloride, sodium chloride, potassium chloride, cationic surfactants (inclusive of cationic dyes) which contain chloride ions, and oxochlorides, which are not limitative. Incidentally, the compounds for supplying the chloride ions may be used singly or in combination of two or more of them.

The concentration of the chloride ions in the pretreating agent according to the present invention is preferably 0.01 to 200 g/L, particularly 0.04 to 100 g/L, more particularly 0.2 to 50 g/L. If the concentration is less than 0.01 g/L, the intended cleaning performance may be unobtainable. On the other hand, if the concentration is more than 200 g/L, it may cause tarnishing of the substrate copper, and economy is lowered.

In the present invention, the component (A) and the component (B) coexist, which is effective in enhancing the adhesion of the copper film deposited by electroplating which is conducted in a later step. This effect arises from the fact that the component (A) restrains the adsorption of a photoresist-eluting component on the metallic surface and the component (B) effectively clean the substrate surface which has copper, whereby copper-copper adhesion is enhanced.

### (C) Nonionic Surfactant

The pretreating agent according to the present invention preferably contains (C) a nonionic surfactant in addition to the component (A) and the component (B). The nonionic surfactant is capable of enhancing the wettability of the work, thereby enhancing the adsorption effect and the cleaning effect. Examples of the nonionic surfactant include surfactants of alkyl ethers, alkyl phenyl ethers, alkylamines, alkylamides, polyhydric alcohol ethers, fatty acid esters, POE polyhydric alcohol fatty acid esters, polyhydric alcohol fatty acid esters, acethylene glycols, or polyoxyalkylenes or polyoxyethylenes which have an average HLB of 10 to 18. As the nonionic surfactants, those which are commercially available can be used.

Where such a nonionic surfactant is used, its concentration is preferably 0.1 to 200 g/L, more preferably 0.5 to 10 g/L. If the concentration is less than 0.1 g/L, the wettability intended may be unobtainable. If the concentration exceeds 200 g/L, on the other hand, it may cause peeling of the photoresist, and economy is lowered.

Incidentally, in the case where a cationic surfactant or an amphoteric surfactant is used as the component (A), and if sufficient wettability is secure, it may be unnecessary to add the component (C).

### (D) Solvent

The pretreating agent according to the present invention preferably contains (D) a solvent in addition to the above-mentioned ingredients. The solvent can act as an assistant in cleaning the substrate copper. Examples of the solvent as the component (D) include water-soluble ethers, amines, alcohols, glycol ethers, ketones, esters, and fatty acids. Particularly, preferable examples include such ethers as dioxane, tetrahydrofuran, etc., such amines as ethylamine, ethanolamine, N-methyl-2-pyrrolidone, N,N-dimethylforamide, etc., such alcohols as methanol, ethanol, propanol, ethylene glycol, propylene glycol, etc., such glycol ethers as ethyl cellosolve, butyl cellosolve, diethylene glycol monoethyl ether, triethylene glycol monoethyl ether, propylene glycol monoethyl ether, etc., such ketones as acetone, methyl ethyl ketone, butyrolactone, etc., such esters as ethyl acetate, propyl acetate, butyl acetate, cellosolve acetate, etc., and such fatty acids as propionic acid, butyric acid, formic acid, acetic acid, lactic acid, etc. Incidentally, these solvents may be used singly or in combination of two or more of them.

Where the solvent is added, the concentration thereof is preferably 0.01 to 200 g/L, particularly 0.1 to 50 g/L. If the concentration is less than 0.01 g/L, enhancement of cleaning performance may be unattainable. If the concentration exceeds 200 g/L, on the other hand, it may bring about peeling of the photoresist, and economy is lowered.

### (E) Acid

The pretreating agent according to the present invention preferably contains (E) an acid in addition to the above-mentioned components. The acid can enhance the effect on removal of the oxide film present on the metal. The acid may be an inorganic acid or an organic acid. Examples of the inorganic acid include sulfuric acid, nitric acid, hydrofluoric acid, and phosphoric acid. Examples of the organic acid include citric acid, formic acid, lactic acid, and alkylsulfonic acid. These acids may be used singly or in combination of two or more of them.

Where the pretreating agent according to the present invention contains the acid, the concentration of the acid in the pretreating agent is preferably 0.1 to 200 g/L, particularly 1 to 100 g/L. If the concentration is less than 0.1 g/L, the effect on removal of the oxide film may be unobtainable. If the concentration is more than 200 g/L, on the other hand, peeling of the photoresist may occur, and economy is lowered.

Incidentally, where hydrochloric acid is used as the supply source of the (B) chloride ions, or where fatty acids are added as the (D) solvent, and if the acid concentration is in the above-mentioned proper range, it is unnecessary to add the component (E).

### (F) Oxidizing Agent

The pretreating agent according to the present invention preferably contains (F) an oxidizing agent in addition to the above-mentioned ingredients. The oxidizing agent can act as an assistant in cleaning the substrate copper. Examples of the oxidizing agent include peroxides, ferric chloride, cupric chloride, and aqueous hydrogen peroxide, which are not limitative. Incidentally, such oxidizing agents may be used singly or in combination of two or more of them.

Where the oxidizing agent is added, its concentration is preferably 0.01 to 200 g/L, particularly 1 to 50 g/L. If the concentration is below 0.01 g/L, enhancement of cleaning performance may be unattainable. If the concentration is more than 200 g/L, it may cause tarnishing of the substrate copper, and economy is lowered.

The pretreating agent according to the present invention is suitably used for pretreatment of a surface of a substrate copper layer (electroless copper plating film or copper foil) on which to form a copper film by copper electroplating, of a printed wiring board provided with a photoresist (ink or dry film) and a photoresist pattern for formation of circuit by forming an electrolytic copper plating film on the substrate copper layer by copper electroplating. As the method of pretreatment, there is preferably adopted a method in which a work is immersed in the pretreating solvent according to the present invention. Where the pretreatment for electroplating is conducted by use of the pretreating agent according to the present invention, the treating temperature is preferably 25 to 50° C., particularly 30 to 45° C. If the pretreating temperature is below 25° C., cleaning may become insufficient. If the temperature is above 50° C., on the other hand, peeling of the photoresist may occur.

In addition, the pretreatment is preferably conducted for a period of time of 1 to 30 minutes, particularly 2 to 10 minutes. If the treating time is less than 1 minute, it may be impossible to obtain a sufficient cleaning effect. If the time exceeds 30 minutes, on the other hand, peeling of the photoresist may be brought about.

Depending on the water washing conditions and the degree of unevenness of drying in a photoresist developing step, the oxide film formed on the substrate copper surface may be rigid, and it may damage adhesion between the substrate copper and the electrolytic copper plating film to be formed thereon. In such a case, it is preferable to carry out an ultrasonic treatment while immersing the work in the pretreating agent according to the present invention. With the ultrasonic treatment used together at the time of the pretreatment, cleaning performance can be enhanced. The ultrasonic treatment may be treated for 1 to 3 minutes at 26 to 42 kHz.

In the case where the oxide film on the substrate copper surface is rigid and it may impair adhesion between the substrate copper and the electrolytic copper plating film, a method may also be adopted in which an electrolyzing treatment is conducted while immersing the work in the pretreating agent according to the present invention. With the electrolyzing treatment used together during the pretreatment, cleaning performance can be enhanced. The electrolyzing treatment may be conducted by anodic electrolysis with direct current, and carried out for 1 to 3 minutes at 0.1 to 5 V or an anodic current density of 0.5 to 1 A/dm² using copper or stainless steel as a cathode.

The electroplating method according to the present invention is a method in which electroplating is conducted after the work is pretreated by use of the pretreating agent according to the present invention. The electroplating method is suitably applicable to copper electroplating. In carrying out the electroplating method, the conventionally known electroplating bath and electroplating conditions can be adopted.

### EXAMPLES

Now, the present invention will be described specifically by showing Examples and Comparative Examples, but the invention is not limited to the Examples.

As a substrate for evaluation, a substrate obtained by adhering a photoresist film to a substrate board R-1705 made by Panasonic Electric Works Co., Ltd. as used. As the photoresist film, Sunfort (ADH252) made by Asahi Kasei E-materials Corp. or Photec (RY-3525) made by Hitachi Chemical Co., Ltd. was used. Line/space was set to be 25 μm/25 μm, and the film thickness of the electrolytic copper plating was set at 20 μm.

### Examples 1-24, Comparative Examples 1-18

Pretreating agents were prepared so as to have compositions as set forth in Tables 2 to 5 below. Adhesion evaluation was carried out according to the following method. Incidentally, in Tables 2 to 5, the units are all g/L.

### Evaluation of Adhesion Between Substrate Copper and Photoresist

The substrate for evaluation having the photoresist film adhered to the substrate board was immersed in the pretreating agent, and the pretreatment was conducted at 35° C. for 3 min. The evaluation substrate thus treated as observed under an optical microscope (magnification: ×200), to evaluate the presence/absence of peeling of the photoresist. When peeling of the photoresist was absent, the adhesion was evaluated as good; when peeling of the photoresist was present, the adhesion was evaluated as bad. The results are also shown in Tables 2 to 5. In Tables 2 to 5, symbol ◯ represents good adhesion, and symbol x represents bad adhesion.

### Evaluation of Adhesion Between Substrate Copper and Plating Film

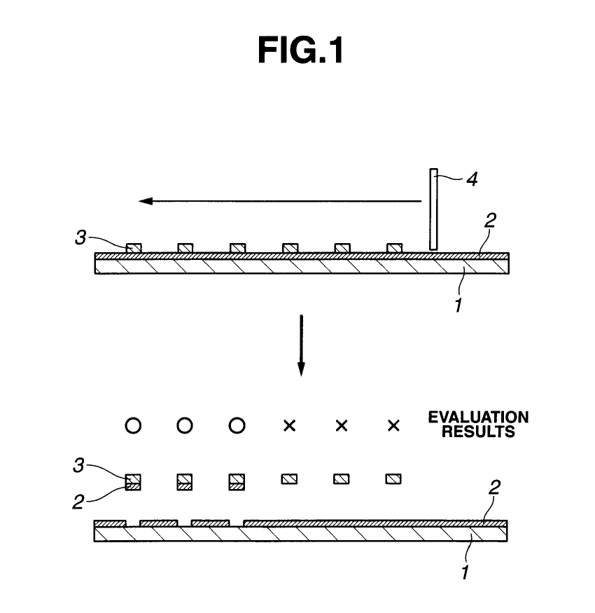

According to the step shown in Table 1 below, the substrate having been subjected to a plating treatment was immersed in a 40 g/L solution of NaOH at 50° C. for 5 min, and the photoresist was stripped. While the evaluation substrate was magnified under an optical microscope (magnification: ×200), as shown in FIG. 1, the cutting edge of a cutter knife 4 was pressed toward the substrate side between the copper wires deposited at L/S=25 μm/25 μm until it came into contact with the substrate copper 2, and the plating film 3 was flipped horizontally. Incidentally, symbol 1 in FIG. 1 denotes the substrate. When the substrate copper was peeled together with the plating film so that the underlying resin was seen, the adhesion was evaluated as good; when only the plating film was peeled so that the substrate copper was seen, the adhesion was evaluated as bad. The evaluation results are also shown in Tables 2 to 5. In Tables 2 to 5, symbol ◯ represents good adhesion, and symbol X represents bad adhesion.

TABLE 1

| | | Concen- | | Temp. | Time | Re- |
|---|---|---|---|---|---|---|
| | Composition | tration | | (° C.) | (min) | marks |
| Pretreatment | Pretreating agent | | | 35 | 3 | |
| Acid cleaning | Sulfuric acid | 100 | g/L | 25 | 1 | |
| Plating using | Copper sulfate | 200 | g/L | 24 | 114 | 1.0 |
| copper sulfate | pentahydrate | | | | | A/dm² |
| | Sulfuric acid | 50 | g/L | | | |
| | Chloride ion | 50 | mg/L | | | |
| | EVF-B¹⁾ | 10 | mL/L | | | |
| | EVF-T²⁾ | 2 | mL/L | | | |
| | EVF-2A³⁾ | 2.5 | mL/L | | | |

Notes:
¹⁾ to ³⁾: All of them are via filling additives for plating bath, made by C. Uyemura & Co., Ltd.

TABLE 2

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Chloride | 35% Hydrochloric acid | 5 | 5 | 5 | 0.1 | | | | | 10 | 5 | 5 | 1 |
| ion | Sodium chloride | | | | | 0.5 | | 0.5 | | | | 5 | |
| | Ammonium chloride | | | | | | 10 | | 10 | | | | 1 |
| Anti- | BDF-R ⁴⁾ | 0.5 | | | | | | 10 | | | 5 | | 1 |
| adsorption | LDM ⁵⁾ | | | | 1 | | | | | | | 10 | |
| agent | Cation BB ⁶⁾ | | 2 | | | | | | 10 | | | | |
| | Cation 2OLR ⁷⁾ | | | | | 10 | | | | | | | 1 |
| | Benzotriazole | | | 10 | | | | | | | 5 | | 1 |
| | Methylphenylpyrazole | | | | | | 0.1 | | | 5 | | | |

| | | | | | | | | | | | | |
|---|---|---|---|---|---|---|---|---|---|---|---|---|
| Adhesion between substrate | ∘ | ∘ | ∘ | ∘ | ∘ | ∘ | ∘ | ∘ | ∘ | ∘ | ∘ | ∘ |
| copper and photoresist | | | | | | | | | | | | |
| Adhesion between substrate | ∘ | ∘ | ∘ | ∘ | ∘ | ∘ | ∘ | ∘ | ∘ | ∘ | ∘ | ∘ |
| copper and plating film | | | | | | | | | | | | |

Notes:
⁴⁾ Betaine-type amphoteric surfactant, made by NOF CORPORATION.
⁵⁾ Amine oxide-type amphoteric surfactant, made by ADEKA CORPORATION.
⁶⁾ Alkyltrimethylammonium-type cationic surfactant, made by NOF CORPORATION.
⁷⁾ Dialkyldimethylammonium-type cationic surfactant, made by NOF CORPORATION.

From the results of Examples 1 to 12, it is seen that the pretreating agents composed of the anti-adsorption agent and the chloride ions were good in adhesion.

TABLE 3

| | | Example | | | | | | | | | | | |
|---|---|---|---|---|---|---|---|---|---|---|---|---|---|
| | | 13 | 14 | 15 | 16 | 17 | 18 | 19 | 20 | 21 | 22 | 23 | 24 |
| Chloride | 35% Hydrochloric acid | 0.5 | | | 10 | | | 5 | | | 5 | | |
| ion | Sodium chloride | | 10 | | | 0.5 | | | 5 | | | 5 | |
| | Ammonium chloride | | | 0.5 | | | 10 | | | 5 | | | 5 |
| Anti- | LDM ⁵⁾ | | 10 | | 0.5 | | | | 10 | | | 0.5 | |
| adsorption | Cation BB ⁶⁾ | 0.5 | | | | 2 | | 5 | | | 10 | | 5 |
| agent | Benzotriazole | | | 5 | | | 10 | | | 2 | | | |
| Nonionic | Newcol 2318 ⁸⁾ | 10 | | | | | 5 | | | 10 | | 0.5 | 5 |
| surfactant | Surfynol 465 ⁹⁾ | | 2 | | | 2 | | | | | 1 | | 5 |
| Acid | 63% Sulfuric acid | | | 0.5 | | | | | | 10 | | 10 | |
| | Citric acid | | | | 0.5 | | | | | | 20 | | 5 |
| Solvent | Ethylene glycol | | | | | 10 | | | | | | | 5 |
| | Ethanol | | | | | | 2 | | | | | | |
| | Butylcarbitol | | | | | | | 10 | | | | | 5 |
| | Acetone | | | | | | | | 0.5 | | | | |
| Oxidizing | 30% Hydrogen peroxide | | | | | | | | | 5 | | 10 | |
| Agent | Sodium persulfate | | | | | | | | | | 10 | | |

| | | | | | | | | | | | | |
|---|---|---|---|---|---|---|---|---|---|---|---|---|
| Adhesion between substrate | ∘ | ∘ | ∘ | ∘ | ∘ | ∘ | ∘ | ∘ | ∘ | ∘ | ∘ | ∘ |
| copper and photoresist | | | | | | | | | | | | |
| Adhesion between substrate | ∘ | ∘ | ∘ | ∘ | ∘ | ∘ | ∘ | ∘ | ∘ | ∘ | ∘ | ∘ |
| copper and plating film | | | | | | | | | | | | |

Notes:
⁸⁾ Polyoxyethylene alkyl ether-type nonionic surfactant, made by Nippon Nyukazai Co., Ltd.
⁹⁾ cetylene glycol-type nonionic surfactant, made by Nisshin Chemical Co., Ltd.

From the results of Examples 13 to 24, it is seen that good adhesion was obtained also in the cases where a nonionic surfactant, an acid, a solvent, and an oxidizing agent were contained in the pretreating agent, in addition to the anti-adsorption agent and the chloride ions.

TABLE 4

| | | Comparative Example | | | | | | | | | |
|---|---|---|---|---|---|---|---|---|---|---|---|
| | | 1 | 2 | 3 | 4 | 5 | 6 | 7 | 8 | 9 | 10 |
| Halogen ion | 35% Hydrochloric acid | 5 | | | | | | | | | |
| (chlorine, | Sodium chloride | | 5 | | | | | | | | |
| bromine, | Ammonium chloride | | | 5 | | | | | | | |
| fluorine) | Sodium bromide | | | | 5 | | 5 | | | | |
| | Sodium fluoride | | | | | 5 | | 5 | | | |
| Anti-adsorption | LDM ⁵⁾ | | | | | | 5 | | 5 | | |
| Agent | Cation BB ⁶⁾ | | | | | | | 5 | | 5 | |
| | Benzotriazole | | | | | | | | | | 5 |
| Nonionic | Newcol 2318 ⁸⁾ | | | | | | | | | | |
| surfactant | | | | | | | | | | | |
| Acid | Sulfuric acid | | | | | | | | | | |
| Solvent | Ethylene glycol | | | | | | | | | | |
| | Butylcarbitol | | | | | | | | | | |
| Oxidizing agent | 30% Hydrogen peroxide | | | | | | | | | | |

| | | | | | | | | | | |
|---|---|---|---|---|---|---|---|---|---|---|
| Adhesion between substrate | ∘ | ∘ | ∘ | ∘ | ∘ | ∘ | ∘ | ∘ | ∘ | ∘ |
| copper and photoresist | | | | | | | | | | |
| Adhesion between substrate | x | x | x | x | x | x | x | x | x | x |
| copper and plating film | | | | | | | | | | |

TABLE 5

| | | Comparative Example | | | | | | | |
|---|---|---|---|---|---|---|---|---|---|
| | | 11 | 12 | 13 | 14 | 15 | 16 | 17 | 18 |
| Halogen ion | 35% Hydrochloric acid | | | | | | | | 2 |
| (chlorine, | Sodium chloride | | | | | | | | |
| bromine, | Ammonium chloride | | | | | | | | |
| fluorine) | Sodium bromide | | | | | | | | |
| | Sodium fluoride | | | | | | | | |
| Anti-adsorption | LDM ⁵⁾ | | | | | | | 2 | |
| agent | Cation BB ⁶⁾ | | | | | | | | |
| | Benzotriazole | | | | | | | | |
| Nonionic | Newcol 2318 ⁸⁾ | 5 | | | | | 2 | 2 | 2 |
| surfactant | | | | | | | | | |
| Acid | Sulfuric acid | | 5 | | | 5 | 5 | 2 | |
| Solvent | Ethylene glycol | | | 5 | | | | | 2 |
| | Butylcarbitol | | | | 5 | | | 2 | |
| Oxidizing agent | 30% Hydrogen peroxide | | | | | 5 | | | 2 |

| | | | | | | | | |
|---|---|---|---|---|---|---|---|---|
| Adhesion between substrate | ∘ | ∘ | ∘ | ∘ | ∘ | ∘ | ∘ | ∘ |
| copper and photoresist | | | | | | | | |
| Adhesion between substrate | x | x | x | x | x | x | x | x |
| copper and plating film | | | | | | | | |

In Comparative Example 16 in which a composition of an acidic pretreating agent ordinarily used in the related art was used, the adhesion between the substrate copper and the plating film was bad. From the results of Comparative Examples 1 to 5 and 8 to 14, it is seen that the adhesion between the substrate copper and the plating film was bad when a solution with a singular composition was used. From the results of Comparative Examples 6 and 7, it is seen that the addition of bromide ions or fluoride ions in place of chloride ions led to bad adhesion between the substrate copper and the plating film. From the results of Comparative Example 15 in which a composition of a microetching solution ordinarily used in the related art was used, it is seen that microetching lead to bad adhesion between the substrate copper and the plating film. From the results of Comparative Example 17, it is seen that the absence of the chloride ions led to bad adhesion between the substrate copper and the plating film. From the results of Comparative Example 18, it is seen that the absence of the anti-adsorption agent resulted in bad adhesion between the substrate copper and the plating film.

### Examples 25-28

Using the pretreating agent of Example 1, adhesion evaluation was conducted in the same manner as in the above-mentioned method, except that the pretreatment was carried out at a treating temperature of 25, 30, 45, or 50° C. The results are shown in Table 6. Adhesion between the substrate copper and the photoresist and adhesion between the substrate copper and the plating film were both good.

TABLE 6

| Example | 25 | 26 | 27 | 28 |
|---|---|---|---|---|
| Treating temperature (° C.) | 25 | 30 | 45 | 50 |
| Adhesion between substrate copper and | ◯ | ◯ | ◯ | ◯ |
| photoresist | | | | |
| Adhesion between substrate copper and | ◯ | ◯ | ◯ | ◯ |
| plating film | | | | |

### Examples 29-33

Using the pretreating agent of Example 1, adhesion evaluation was conducted in the same manner as the above-mentioned method, except that the pretreatment was carried out for a period of time of 1, 5, 10, 20, or 30 min. The results are shown in Table 7. Adhesion between the substrate copper and the photoresist and adhesion between the substrate copper and the plating film were both good.

TABLE 7

| Example | 29 | 30 | 31 | 32 | 33 |
|---|---|---|---|---|---|
| Treating temperature (° C.) | 1 | 5 | 10 | 20 | 30 |
| Adhesion between substrate copper and | ◯ | ◯ | ◯ | ◯ | ◯ |
| photoresist | | | | | |
| Adhesion between substrate copper and | ◯ | ◯ | ◯ | ◯ | ◯ |
| plating film | | | | | |

### Reference Example 1

An evaluation substrate before being subjected to the pretreatment of the step shown in Table 1 was heat-treated at 120° C. for 2 hr, to oxidize the surface of the substrate. Thereafter, using the pretreating agent of Example 1 and according to the above-mentioned method, adhesion between the substrate copper and the plating film was conducted. The result is shown in Table 8.

### Example 34

Evaluation of adhesion between the substrate copper and the plating film was conducted in the same manner as in the above-mentioned method, except that the evaluation substrate before being subjected to the pretreatment of the step shown in Table 1 was heat-treated at 120° C. for 2 hr, to oxidize the surface of the substrate, and then an ultrasonic treatment was conducted while immersing the evaluation substrate in the pretreating agent of Example 1 in the pretreatment of the step shown in Table 1. The result is shown in Table 8.

### Example 35

Evaluation of adhesion between the substrate copper and the plating film was conducted in the same manner as in the above-mentioned method, except that the evaluation substrate before being subjected to the pretreatment of the step shown in Table 1 was heat-treated at 120° C. for 2 hr, to oxidize the surface of the substrate, and then an electrolyzing treatment (0.5 V) was conducted while immersing the evaluation substrate in the pretreating agent of Example 1 in the pretreatment of the step shown in Table 1. The result is shown in Table 8.

TABLE 8

| | Reference | | |
|---|---|---|---|
| | Example 1 | Example 34 | Example 35 |
| Treatment used together | none | ultrasonic | electrolyzing |
| | | treatment | treatment |
| Adhesion between substrate | partly bad | ◯ | ◯ |
| copper and plating film | adhesion | | |

From the result of Reference Example 1, it is seen that the presence of the oxide film on the substrate surface led to partly bad adhesion. From the results of Examples 34 and 35, it is seen that when the ultrasonic treatment or the electrolyzing treatment was used together with the pretreatment in the case where the oxide film was present on the substrate surface, the problem of bad adhesion was solved.

Japanese Patent Application No. 2010-045405 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A pretreating agent for electroplating comprising an aqueous solution containing:
(A) at least one anti-adsorption agent selected from the group consisting of a triazole compound, a pyrazole compound, an imidazole compound, a cationic surfactant and an amphoteric surfactant; and
(B) chloride ion.

2. The pretreating agent for electroplating according to claim 1, wherein the component (A) is at least one selected from the group consisting of a cationic surfactant and an amphoteric surfactant.

3. The pretreating agent for electroplating according to claim 2, wherein the component (A) is an amphoteric surfactant.

4. The pretreating agent for electroplating according to claim 1, wherein the aqueous solution further contains
(C) a nonionic surfactant.

5. The pretreating agent for electroplating according to claim 1, wherein the aqueous solution further contains
(D) at least one solvent selected from the group consisting of water-soluble ethers, amines, alcohols, glycol ethers, ketones, esters, and fatty acids.

6. The pretreating agent for electroplating according to claim 5, wherein the component (D) comprises at least one solvent selected from the group consisting of water-soluble ethers, alcohols, ketones, esters, and fatty acids.

7. The pretreating agent for electroplating according to claim 1, wherein the aqueous solution further contains
(E) an acid.

8. The pretreating agent for electroplating according to claim 1, wherein the aqueous solution further contains
(F) an oxidizing agent.

9. A pretreatment method for electroplating, comprising immersing a work in the pretreating agent for electroplating defined in claim 1.

10. A pretreatment method for electroplating, comprising immersing a work in the pretreating agent for electroplating defined in claim 1, while an ultrasonic treatment is conducted.

11. A pretreatment method for electroplating, comprising immersing a work in the pretreating agent for electroplating defined in claim 1, while an electrolyzing treatment is conducted.

12. An electroplating method wherein the pretreatment method for electroplating defined in claim 9 is used.

13. An electroplating method wherein the pretreatment method for electroplating defined in claim 10 is used.

14. An electroplating method wherein the pretreatment method for electroplating defined in claim 11 is used.
